(19) United States
(12) Patent Application Publication
(10) Pub. No.: US 2026/0243727 A1
(43) Pub. Date: Aug. 20, 2026

(54) SYSTEM AND METHOD FOR AUTOMATED SPLIT INJECTION FOR CAPILLARY ELECTROPHORESIS

(71) Applicant: Georgia Tech Research Corporation, Atlanta, GA (US)

(72) Inventors: Peter Julian Hesketh, Atlanta, GA (US); Daniel Struk, Atlanta, GA (US)

(21) Appl. No.: 19/541,359

(22) Filed: Feb. 16, 2026

Related U.S. Application Data
(60) Provisional application No. 63/759,330, filed on Feb. 17, 2025.

(51) Int. Cl. G01N 27/447

(52) U.S. Cl. CPC G01N 27/44791; G01N 27/4473

(57) ABSTRACT

The present disclosure relates to capillary electrophoresis systems and methods, particularly a capillary electrophoresis system using a sampling channel with controlled volume for automated split injection to improve reproducibility and increase dynamic range for multi-ion analysis. A capillary electrophoresis system includes a separation column configured to perform electrophoretic separation of ions, a sampling column in fluid communication with the separation column configured to receive a sample and buffer solution, a pump in fluid communication with the sampling column configured to control sample volume drawn into the sampling column, and valves configured to direct fluid flow between the sampling column and separation column, wherein actuation of the valves enables a variable split ratio of sample volume relative to buffer solution to be introduced into the separation column.

### CROSS-REFERENCE TO RELATED APPLICATIONS

This application claims the benefit of U.S. Provisional Application Serial No. 63/759,330, entitled "System and Method for Automated Split Injection for Capillary Electrophoresis," filed on 17 February 2025, which is incorporated herein by reference in its entirety as if fully set forth below.

### FIELD OF INVENTION

The present disclosure relates to capillary electrophoresis systems and methods, and more particularly to a capillary electrophoresis system using a sampling channel with controlled volume for automated split injection to improve reproducibility of sample analysis and increase dynamic range for multi-ion analysis.

### BACKGROUND

Capillary electrophoresis is an analytical separation technique that utilizes electric fields to separate ionic species within narrow capillary tubes. The technique has been employed in various analytical chemistry applications, including the analysis of water samples, environmental monitoring, and characterization of chemical compositions in industrial processes. Current capillary electrophoresis systems typically include separation columns, detection systems such as capacitively-coupled contactless conductivity detectors, pumps for fluid handling, and various valve arrangements for directing sample and buffer flow through the system. These systems can analyze multiple ionic species in a single measurement, including cations such as sodium, potassium, lithium, calcium, and magnesium, as well as anions such as nitrate, nitrite, and phosphate. Ion analysis using capillary electrophoresis has applications in wastewater treatment plants, environmental sensing of lake and river water composition, and characterization of agricultural waste streams for potential recycling into fertilizer products.

However, existing capillary electrophoresis technologies face several limitations. Current versions of such systems operate primarily at laboratory bench scale and are not easily portable or robust for field deployment. Sample injection in conventional systems often lacks reproducibility, leading to variability in analytical results between measurements. Additionally, present systems have limited dynamic range, making it difficult to analyze samples with widely varying ion concentration levels, such as those encountered in complex waste streams where higher concentration species like ammonia coexist with lower concentration targets such as nitrate, nitrite, and trace metal ions. Ion-selective electrodes, which represent an alternative approach to ion analysis, can measure only one ion per electrode and experience difficulties with stability and calibration. These deficiencies present challenges for applications requiring portable, reliable, and versatile multi-ion analysis capabilities.

What is needed, therefore, is an improved capillary electrophoresis system that provides enhanced reproducibility of sample analysis through controlled sample injection and increased dynamic range for analysis of samples with varying ion concentration levels. Such a system would enable more portable and integrated multi-ion analysis compared to laboratory-scale instruments while maintaining the ability to analyze multiple ions simultaneously.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A capillary electrophoresis system can include a separation column configured to perform electrophoretic separation of ions. The capillary electrophoresis system can include a sampling column in fluid communication with the separation column. The sampling column can be configured to receive a sample and a buffer solution. The capillary electrophoresis system can include a pump in fluid communication with the sampling column. The pump can be configured to control a volume of the sample drawn into the sampling column. The capillary electrophoresis system can include a plurality of valves configured to direct fluid flow between the sampling column and the separation column. Actuation of the plurality of valves can enable a variable split ratio of the sample volume in the sampling column relative to the buffer solution to be introduced into the separation column.

A method for performing capillary electrophoresis can include drawing a controlled volume of a sample into a sampling column using a pump. The sampling column can contain a buffer solution. The method can include actuating a plurality of valves to establish a fluid pathway between the sampling column and a separation column. The method can include introducing the sample from the sampling column into the separation column at a split ratio determined by the controlled volume of the sample relative to the buffer solution in the sampling column. The method can include applying a voltage across the separation column to perform electrophoretic separation of ions in the sample. The method can include detecting the separated ions using a detector.

A capillary electrophoresis system for multi-ion analysis can include a separation column having an inlet and an outlet. The capillary electrophoresis system can include a sampling column connected to the inlet of the separation column. The sampling column can define a channel configured to hold a variable volume of a sample. The capillary electrophoresis system can include a syringe pump configured to draw the sample into the sampling column and to control the volume of the sample in the channel. The capillary electrophoresis system can include a detector positioned at the outlet of the separation column and configured to detect separated ions. The capillary electrophoresis system can include a valve arrangement configured to selectively connect the sampling column to a sample reservoir and to the separation column. The valve arrangement can be operable to achieve a variable split of the sample volume introduced into the separation column.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a block diagram of a capillary electrophoresis system, according to examples of the disclosed technology.

FIG. 2 illustrates a capillary electrophoresis system showing flow paths and valve arrangement for automated split injection, according to examples of the disclosed technology.

FIG. 3 illustrates a calibration graph showing concentration versus peak height for sodium and potassium ions, according to examples of the disclosed technology.

FIG. 4 illustrates a graph showing signal intensity as a function of time for capillary electrophoresis runs with varying potassium to sodium ratios, according to examples of the disclosed technology.

FIG. 5 illustrates a graph showing detector response as a function of time for multiple experimental runs, according to examples of the disclosed technology.

FIG. 6 illustrates a graph showing the relationship between injection volume and peak height, according to examples of the disclosed technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to capillary electrophoresis systems and methods for multi-ion analysis. Capillary electrophoresis can be used for analysis of incoming waste streams or for samples taken at intermediate points in chemical processing. The systems and methods disclosed herein provide for automated sample injection with controlled volume, which can improve reproducibility of sample analysis. The systems and methods can also provide variable split ratios of sample volume relative to buffer solution, which can increase dynamic range for analysis of a greater range of ion concentration levels.

Ion analysis can be performed at wastewater treatment plants and for environmental sensing of lake water and river water composition. The systems and methods disclosed herein can measure the composition of waste from poultry, cattle, or swine for recycling into fertilizer. The disclosed capillary electrophoresis systems can provide a more portable analysis of ion concentration compared to laboratory-scale instruments such as inductively coupled plasma spectroscopy, ion chromatography, and ionization spectroscopy. The disclosed systems can also analyze multiple ions at one time, in contrast with ion-selective electrodes which can measure one ion for each electrode and can have difficulty with stability and calibration.

The capillary electrophoresis systems disclosed herein can use a sampling column with controlled volume that can split the ratio of sample injected into the flow for analysis. The split ratio can be varied by changing the sampled volume in the sampling column relative to pre-filled buffer in the sampling column. The systems can include a pump configured to control pumping time, which can change the injected sample volume in the sampling column. The systems can further include a plurality of valves configured to direct fluid flow between the sampling column and a separation column, enabling the variable split ratio of sample volume to be introduced into the separation column.

The capillary electrophoresis systems and methods disclosed herein can provide utility for analysis of multi-ion mixtures. Such multi-ion mixtures can include mixtures from agricultural waste, including concentrated animal feeding operation waste and poultry waste water from farms. The analysis of such multi-ion mixtures can enable recycling of phosphates and ammonia for sustainable production of fertilizer. The systems can be configured to measure ions including ammonium, nitrate, nitrite, phosphate, potassium, sodium, calcium, lithium, magnesium, and zinc. The systems can be designed to be inexpensive, sensitive, rapid, reliable, and modular, supporting distributed modular fertilizer production systems that recycle waste streams from concentrated animal feeding operations and wastewater treatment plants.

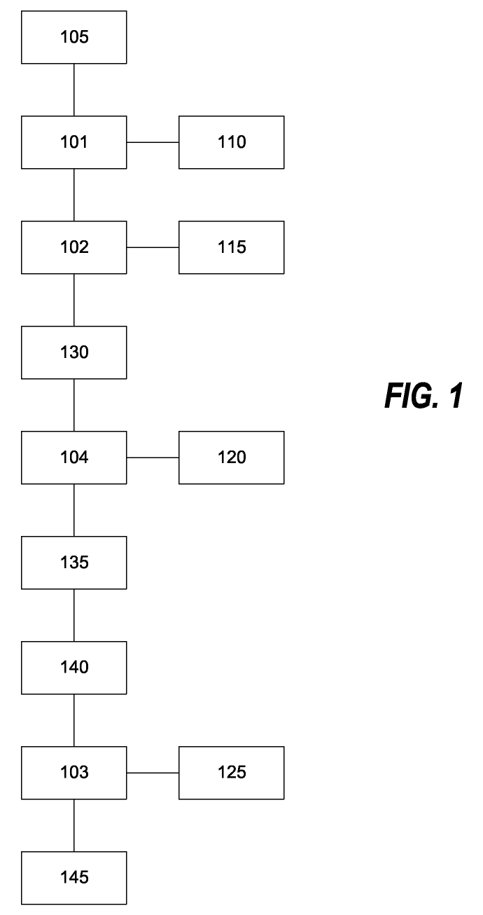

Referring to FIG. 1, a block diagram of a capillary electrophoresis system is illustrated. The capillary electrophoresis system includes a separation column 135 configured to perform electrophoretic separation of ions. The separation column 135 has an inlet and an outlet. A sampling column 130 is connected to the inlet of the separation column 135 and is in fluid communication with the separation column 135. The sampling column 130 is configured to receive a sample and a buffer solution. The sampling column 130 defines a channel configured to hold a variable volume of a sample.

With continued reference to FIG. 1, the capillary electrophoresis system includes a syringe pump 105 in fluid communication with the sampling column 130. The syringe pump 105 can be referred to herein as a pump configured to control a volume of the sample drawn into the sampling column 130. The syringe pump 105 is configured to draw the sample into the sampling column 130 and to control the volume of the sample in the channel. The syringe pump 105 is configured to control a pumping time to vary the volume of the sample drawn into the sampling column 130.

The capillary electrophoresis system includes a plurality of valves configured to direct fluid flow between the sampling column 130 and the separation column 135. As shown in FIG. 1, the plurality of valves comprises at least three 3-port valves configured to selectively direct fluid flow between various reservoirs, the sampling column 130, and the separation column 135. A first 3-port valve 101 is connected to the syringe pump 105. A second 3-port valve 102 is connected to the first 3-port valve 101 and to the sampling column 130. A third 3-port valve 103 is positioned downstream of the separation column 135. Actuation of the plurality of valves enables a variable split ratio of the sample volume in the sampling column 130 relative to the buffer solution to be introduced into the separation column 135. The plurality of valves can be referred to herein as a valve arrangement configured to selectively connect the sampling column 130 to a sample reservoir and to the separation column 135. The valve arrangement is operable to achieve a variable split of the sample volume introduced into the separation column 135.

As further shown in FIG. 1, the capillary electrophoresis system includes a 3-way tee 104 positioned between the sampling column 130 and the separation column 135. The 3-way tee 104 provides a fluid connection point that enables the sampling column 130 to receive sample from a sample reservoir 120. The sample reservoir 120 is in fluid communication with the sampling column 130 through at least one of the plurality of valves and through the 3-way tee 104.

The capillary electrophoresis system includes a rinsing reservoir 110 in fluid communication with the first 3-port valve 101. The first 3-port valve 101 is configured to selectively direct fluid flow from the rinsing reservoir 110 through the system. An HV/buffer reservoir 115 is in fluid communication with the second 3-port valve 102. The HV/buffer reservoir 115 can be referred to herein as a buffer reservoir. The plurality of valves is configured to selectively direct fluid flow between the rinsing reservoir 110, the HV/buffer reservoir 115, the sampling column 130, and the separation column 135. A GND/buffer reservoir 125 is in fluid communication with the third 3-port valve 103 and provides a ground reference for the electrophoretic separation process.

With continued reference to FIG. 1, the capillary electrophoresis system includes a C4D detector 140 positioned at the outlet of the separation column 135. The C4D detector 140 is a capacitively-coupled contactless conductivity detector in fluid communication with the separation column 135. The capacitively-coupled contactless conductivity detector is configured to detect ions separated by the separation column 135. The C4D detector 140 can be referred to herein as a detector configured to detect separated ions. A waste 145 is positioned downstream of the third 3-port valve 103 for disposal of analyzed samples.

The syringe pump 105 and the plurality of valves including the 3-port valves 101, 102, and 103 can be sourced from LabSmith as off-the-shelf components for the capillary electrophoresis system. The capillary electrophoresis system is designed to be compact, inexpensive, sensitive, rapid, reliable, and modular for distributed fertilizer production applications.

The separation column 135 can have an inner diameter in a range of 75 micrometers to 150 micrometers. In some cases, the separation column 135 has an inner diameter of 100 micrometers. The separation column 135 can have a length of, e.g., 20-30 cm or about 25 cm, for performing electrophoretic separation of ions. The sampling column 130 can have an inner diameter in a range of 50 micrometers to 100 micrometers. In some cases, the sampling column 130 has an inner diameter of 75 micrometers.

The capillary electrophoresis system can include a high voltage source configured to apply a voltage difference in a range of 5 kV to 15 kV across the separation column 135. The high voltage source can comprise an Emco CB101N DC-DC converter for generating the voltage applied across the separation column 135. In some cases, the voltage difference applied between the high voltage and ground electrodes is -10 kV for performing electrophoretic separation. The high voltage source can be connected to the HV/buffer reservoir 115 and the GND/buffer reservoir 125 to establish the voltage difference across the separation column 135.

The volume of the sample drawn into the sampling column 130 can be in a range of 0.05 microliters to 0.3 microliters. The syringe pump 105 can control the pumping time to vary the volume of the sample drawn into the sampling column 130 within this range. Varying the sample volume within this range can enable adjustment of the split ratio of sample to buffer introduced into the separation column 135, which can increase the dynamic range for analysis of varying ion concentration levels.

The capillary electrophoresis system can include a data acquisition device connected to the capacitively-coupled contactless conductivity detector. The data acquisition device can comprise an Arduino microcontroller connected to the C4D detector 140 for recording detection data. The data acquisition device is configured to record detection data from the capacitively-coupled contactless conductivity detector. The Arduino microcontroller can receive signals from the C4D detector 140 and convert the signals into digital data for storage and analysis.

As described previously, the detector comprises a capacitively-coupled contactless conductivity detector positioned at the outlet of the separation column 135. The capacitively-coupled contactless conductivity detector detects ions separated by the separation column 135 through contactless conductivity measurement. The data acquisition device is configured to record detection data corresponding to the separated ions as the separated ions pass through the capacitively-coupled contactless conductivity detector.

The Arduino microcontroller can be programmed to collect data during the separation process and to store the detection data for subsequent analysis. The detection data can include signal intensity values corresponding to the conductivity of the separated ions as the separated ions elute from the separation column 135. The data acquisition device can record the detection data as a function of time, enabling generation of electropherograms that display peaks corresponding to different ionic species in the sample.

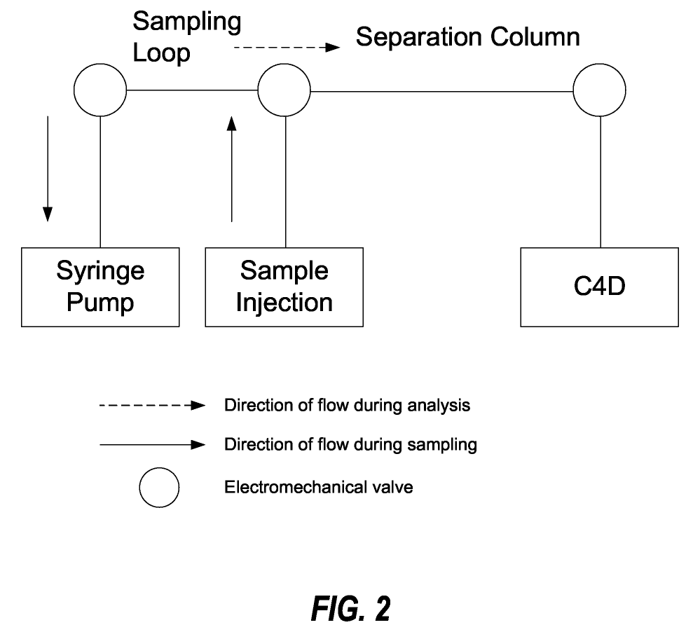

Referring to FIG. 2, a system diagram of a capillary electrophoresis system is illustrated showing flow paths and valve arrangement for automated split injection. The system diagram depicts the arrangement of components including a syringe pump, a sample injection component, a sampling loop, a separation column, and a C4D detector. The sampling loop can be referred to herein as a sampling column as described previously with reference to FIG. 1.

The valve arrangement comprises a plurality of electromechanical valves configured to control fluid pathways between the various components of the capillary electrophoresis system. As shown in FIG. 2, the electromechanical valves are represented by circles positioned at connection points between the syringe pump and the sampling loop, between the sample injection component and the sampling loop, and between the sampling loop and the separation column. The electromechanical valves can be actuated to selectively open or close fluid pathways, enabling the system to operate in different modes.

With continued reference to FIG. 2, the valve arrangement is configured to switch between a sampling mode and an analysis mode. In the sampling mode, the sample is drawn into the sampling column. The direction of flow during sampling is indicated by a solid arrow in FIG. 2, showing flow from the syringe pump toward the sampling loop. During the sampling mode, the syringe pump draws sample from the sample injection component into the sampling loop through actuation of the electromechanical valves. The volume of sample drawn into the sampling loop can be controlled by the pumping time of the syringe pump.

In the analysis mode, the sample is directed from the sampling column to the separation column. The direction of flow during analysis is indicated by a dashed arrow in FIG. 2, showing flow from the sampling loop toward the separation column. During the analysis mode, the electromechanical valves are actuated to establish a fluid pathway that directs the sample contained in the sampling loop through the separation column where ion separation occurs. The separated ions are then detected by the C4D detector positioned downstream of the separation column.

The valve arrangement enables controlled volume injection by allowing precise control over the amount of sample drawn into the sampling loop during the sampling mode. The valve arrangement also enables variable split ratios of the sample volume introduced into the separation column. By varying the volume of sample drawn into the sampling loop relative to the buffer solution pre-filled in the sampling loop, different split ratios can be achieved. The variable split ratios can improve reproducibility of sample analysis by providing consistent sample volumes for each analysis run. The variable split ratios can also increase dynamic range for analysis of varying ion concentration levels by allowing adjustment of the amount of sample introduced into the separation column based on the expected concentration of ions in the sample.

A method for performing capillary electrophoresis can include a rinsing phase, a sampling phase, and a separation phase. The method can be performed using the capillary electrophoresis system described previously.

The method can include rinsing the sampling column with the buffer solution prior to drawing the controlled volume of the sample into the sampling column. Rinsing the sampling column comprises actuating at least one of the plurality of valves to direct the buffer solution from a rinsing reservoir through the sampling column. During the rinsing phase, the pump pulls buffer from the rinsing reservoir and pushes the buffer through the sampling column. The valve connected to the separation column can be closed during the initial portion of the rinsing phase to direct buffer through the sampling column. The valve connected to the separation column can then be opened to rinse the separation column with buffer. The rinsing phase prepares the sampling column and separation column for subsequent sample analysis by removing residual sample or contaminants from previous analysis runs.

The method includes drawing a controlled volume of a sample into a sampling column using a pump, wherein the sampling column contains a buffer solution. During the sampling phase, the valve connected to the separation column is closed, and the pump draws a controlled amount of sample into the sampling column. The controlled volume of the sample can be in a range of 0.05 microliters to 0.3 microliters. The pump can control the pumping time to vary the volume of sample drawn into the sampling column within this range. The sampling column contains buffer solution from the rinsing phase, and the controlled volume of sample drawn into the sampling column displaces a portion of the buffer solution.

The method includes actuating a plurality of valves to establish a fluid pathway between the sampling column and a separation column. During the separation phase, the valves are actuated to connect the sampling column to a high voltage source and to connect the detector to ground. The valve arrangement establishes a continuous fluid pathway from the sampling column through the separation column to the detector.

The method includes introducing the sample from the sampling column into the separation column at a split ratio determined by the controlled volume of the sample relative to the buffer solution in the sampling column. The split ratio can be varied by changing the volume of sample drawn into the sampling column during the sampling phase. A larger volume of sample drawn into the sampling column results in a higher proportion of sample relative to buffer being introduced into the separation column. A smaller volume of sample drawn into the sampling column results in a lower proportion of sample relative to buffer being introduced into the separation column. The variable split ratio can improve reproducibility of sample analysis and can increase dynamic range for analysis of varying ion concentration levels.

The method includes applying a voltage across the separation column to perform electrophoretic separation of ions in the sample. After the fluid pathway is established, a high voltage is applied across the separation column. The voltage can be in a range of 5 kV to 15 kV. In some cases, a voltage difference of -10 kV is applied between the high voltage and ground electrodes. The applied voltage causes ions in the sample to migrate through the separation column at different rates based on the charge and size of the ions, resulting in electrophoretic separation of the ions.

The method includes detecting the separated ions using a detector. As described previously, the detector can comprise a capacitively-coupled contactless conductivity detector. The detector detects the separated ions as the separated ions elute from the separation column. Detection data can be recorded by a data acquisition device connected to the detector.

The method can include flushing the capillary with buffer between each run to prepare for subsequent sample analysis. The inter-run buffer flushing removes residual sample from the sampling column and separation column. The flushing can be performed by actuating the valves to direct buffer from the rinsing reservoir through the sampling column and separation column. The inter-run buffer flushing can improve reproducibility of sample analysis by providing consistent starting conditions for each analysis run.

The capillary electrophoresis system can utilize various buffer solutions for separation of different ionic species. A buffer solution can comprise 5 mM imidazole, 3 mM 18-crown-6 ether, pH-balanced to 4.3 with acetic acid for cation separation. The imidazole/crown ether buffer provides a background electrolyte that enables separation of cations based on differences in electrophoretic mobility. The 18-crown-6 ether component can complex with certain cations, which can modify the electrophoretic mobility of the complexed cations and improve separation resolution between different cationic species.

An alternative buffer solution can comprise 12 mM Histidine and 2 mM 18-crown-6 ether, balanced to a pH of 4 with acetic acid for alkaline metal separation. The histidine/crown ether buffer can be used for calibration and analysis of alkaline metal ions including lithium, sodium, and potassium. The histidine component provides buffering capacity at the acidic pH used for separation, while the 18-crown-6 ether component can selectively complex with potassium ions to modify the separation characteristics.

The sample can comprise one or more ions selected from the group consisting of ammonium, nitrate, nitrite, phosphate, potassium, sodium, calcium, lithium, magnesium, and zinc. The capillary electrophoresis system can separate and detect multiple ions in a single analysis run. Cations such as ammonium, potassium, sodium, calcium, lithium, magnesium, and zinc can be separated using the imidazole/crown ether buffer or the histidine/crown ether buffer. Anions such as nitrate, nitrite, and phosphate can be separated using appropriate buffer compositions for anion analysis. The ability to analyze multiple ions at one time provides advantages over ion-selective electrodes, which can measure one ion for each electrode.

The method for performing capillary electrophoresis can include adding a marker ion to the sample prior to drawing the controlled volume of the sample into the sampling column. The marker ion can comprise lithium chloride (LiCl) added at 5 mM concentration to provide a lithium ion marker. The lithium ion marker is eluted from the separation column after other cations in the sample due to the electrophoretic mobility characteristics of lithium ions.

The marker ion is used to normalize elution times of other ions in the sample. Elution times in capillary electrophoresis can be sensitive to changes in the pH of the sample or buffer, temperature, and the concentration of analytes in the sample. By adding an ion not naturally found within the sample, such as lithium, the lithium ion can be used as an internal standard. Factors affecting elution time affect the lithium ion marker as well as other ions in the sample, so that elution times can be normalized relative to the lithium elution time. The normalized elution times can improve identification of ionic species across different analysis runs and can enable comparison of analysis results from different laboratories or different instruments.

For calibration, mixtures of varying concentrations between 0.5 mM and 10 mM of alkaline metals including lithium, sodium, and potassium can be injected into the capillary electrophoresis system. The calibration mixtures can be prepared with the lithium ion marker at a constant concentration while varying the concentrations of sodium and potassium. Alternatively, the concentration of sodium and potassium can be held constant while the concentration of lithium is varied. The calibration data can be used to generate calibration curves relating peak height or peak area to ion concentration for quantitative analysis of unknown samples.

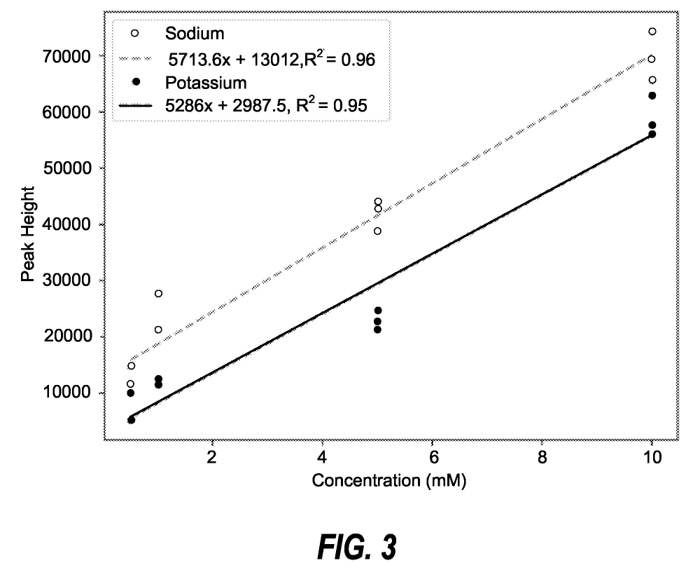

Referring to FIG. 3, a calibration graph is illustrated showing the relationship between concentration and peak height for sodium and potassium ions in the capillary electrophoresis system. The horizontal axis of the calibration graph represents concentration measured in millimolar units, ranging from approximately 0 to 10 mM. The vertical axis represents peak height, ranging from approximately 0 to 70000 units. The calibration graph displays data points for sodium ions represented by open circles and data points for potassium ions represented by filled circles.

The calibration mixtures have varying concentrations between 0.5 mM and 10 mM of alkaline metals including lithium, sodium, and potassium. The calibration range of 0.5-10 mM provides a range of concentrations suitable for establishing calibration curves for quantitative analysis of unknown samples. The calibration mixtures can be injected into the capillary electrophoresis system via the sampling reservoir for establishing the calibration curves.

With continued reference to FIG. 3, a linear regression fit for sodium is represented by a dashed line with the equation 5713.6x + 13012 and a coefficient of determination of 0.96. A linear regression fit for potassium is represented by a solid line with the equation 5286x + 2987.5 and a coefficient of determination of 0.95. The coefficients of determination indicate that the linear regression fits provide a good correlation between concentration and peak height for both sodium and potassium ions within the calibration range.

The data points for both sodium and potassium ions show a positive linear correlation between concentration and peak height. Sodium exhibits consistently higher peak height values than potassium at equivalent concentrations across the calibration range. Multiple replicate measurements are visible at each concentration level in FIG. 3, demonstrating the reproducibility of the analysis performed using the capillary electrophoresis system.

The calibration curves can be used for quantitative analysis of unknown samples by measuring the peak height of sodium and potassium ions in the unknown sample and determining the corresponding concentration from the linear regression equations. The calibration data can be generated using a buffer of 5 mM imidazole, 3 mM 18-crown-6 ether, pH-balanced to 4.3 with acetic acid as described previously. Between each calibration run, the capillary can be flushed with buffer to prepare for subsequent sample injection.

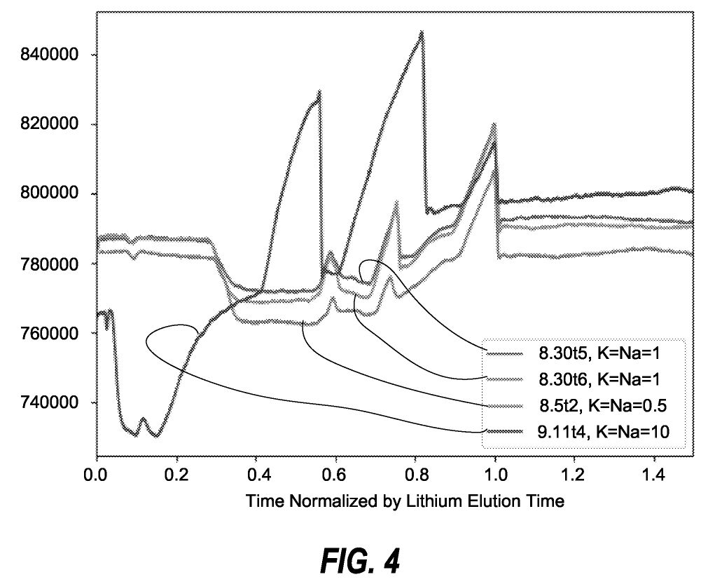

Referring to FIG. 4, a graph is illustrated showing signal intensity as a function of time normalized by lithium elution time for multiple capillary electrophoresis runs with varying potassium to sodium ratios. The vertical axis of the graph represents signal intensity values ranging from approximately 740000 to 840000. The horizontal axis represents time normalized by lithium elution time ranging from 0.0 to 1.4. The normalization of time by lithium elution time enables comparison of electropherograms across different analysis runs by accounting for variations in elution time caused by changes in pH, temperature, or analyte concentration.

Four different experimental conditions are plotted in FIG. 4, identified as 8.30t5 with K=Na=1, 8.30t6 with K=Na=1, 8.5t2 with K=Na=0.5, and 9.11t4 with K=Na=10. The different potassium to sodium ratios represent samples with varying relative concentrations of potassium and sodium ions. The traces corresponding to K=Na=1 represent samples where potassium and sodium are present at equal concentrations. The trace corresponding to K=Na=0.5 represents a sample where potassium concentration is half of the sodium concentration. The trace corresponding to K=Na=10 represents a sample where potassium concentration is ten times the sodium concentration.

With continued reference to FIG. 4, each trace exhibits characteristic peaks at different normalized time positions corresponding to the elution of different ionic species. The traces demonstrate an initial dip in signal intensity near a normalized time of approximately 0.2, followed by distinct peaks occurring between normalized times of approximately 0.4 and 1.0. The positions of the peaks along the normalized time axis correspond to the electrophoretic mobilities of the different ionic species in the sample. Ions with higher electrophoretic mobility elute earlier and appear at lower normalized time values, while ions with lower electrophoretic mobility elute later and appear at higher normalized time values.

The peak heights and positions vary depending on the potassium to sodium ratio of each sample. As shown in FIG. 4, the trace corresponding to K=Na=10 exhibits the highest peak intensity reaching approximately 845000, while the traces with lower potassium to sodium ratios show correspondingly lower peak intensities. The variation in peak height with ion concentration ratio demonstrates the quantitative relationship between ion concentration and detector response in the capillary electrophoresis system. Samples with higher concentrations of a particular ionic species produce higher peak intensities for the corresponding peak in the electropherogram.

The graph in FIG. 4 illustrates the reproducibility of the capillary electrophoresis analysis. The two traces corresponding to K=Na=1 (8.30t5 and 8.30t6) show similar peak positions and intensities, demonstrating that replicate analyses of samples with the same ion concentration ratios produce consistent electropherogram profiles. The reproducibility of the analysis can be attributed to the automated split injection method that provides controlled sample volumes for each analysis run.

The electropherogram signal profiles in FIG. 4 demonstrate how varying ion concentration ratios affect the resulting signal characteristics. Changes in the relative concentrations of potassium and sodium ions produce corresponding changes in the relative heights of the peaks associated with each ionic species. The ability to distinguish between samples with different ion concentration ratios based on the electropherogram signal profiles enables quantitative analysis of multi-ion mixtures. The normalized time axis enables identification of ionic species based on their characteristic elution positions relative to the lithium ion marker, which elutes at a normalized time of 1.0 by definition.

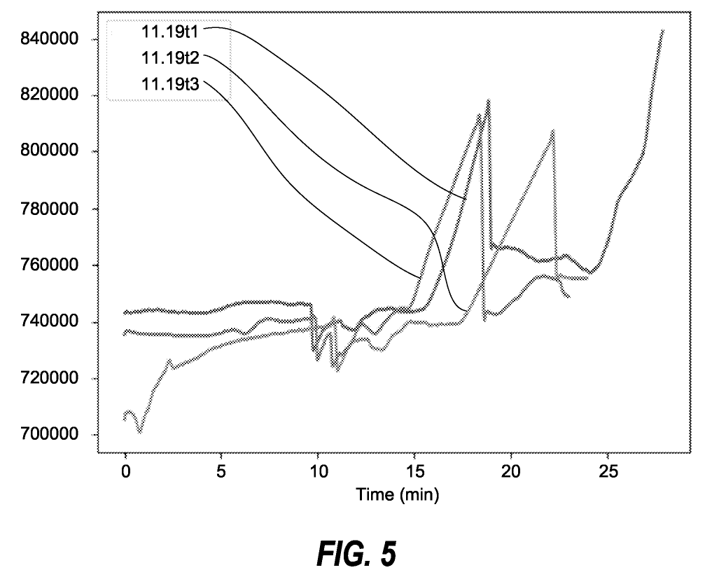

Referring to FIG. 5, a graph is illustrated showing detector response as a function of time for three experimental runs labeled 11.19t1, 11.19t2, and 11.19t3. The vertical axis of the graph represents detector signal values ranging from approximately 700000 to 840000. The horizontal axis represents time in minutes ranging from 0 to approximately 27 minutes. The three traces are overlaid on the same graph to enable direct comparison of the detector response patterns across the different experimental runs.

The three traces in FIG. 5 correspond to three separate analysis runs performed using the capillary electrophoresis system with a fixed sample volume. Each trace displays similar overall patterns with characteristic peaks occurring at various time points during the separation process. The peaks appearing at approximately 17 to 18 minutes correspond to the elution of ionic species from the separation column. Additional peaks occur between 20 and 25 minutes, corresponding to the elution of ionic species with lower electrophoretic mobilities.

With continued reference to FIG. 5, one trace shows an initial signal value starting near 700000 and rising to approximately 745000 within the first 5 minutes, while the other two traces begin at higher signal values near 745000. The variation in initial signal values can be attributed to baseline differences between runs. Despite the differences in initial baseline values, the three traces exhibit consistent peak patterns during the later portion of the analysis. The peaks occur at similar time positions across all three runs, and the relative heights of the peaks are consistent between runs.

The consistent peak patterns across the three experimental runs demonstrate the reproducibility of the capillary electrophoresis analysis achieved through the automated split injection approach. The automated split injection method provides controlled sample volumes for each analysis run by drawing a fixed volume of sample into the sampling column using the pump. The fixed sample volume results in a consistent split ratio of sample to buffer being introduced into the separation column for each run. The consistent split ratio produces consistent peak heights and peak positions in the resulting electropherograms.

All three traces in FIG. 5 exhibit fluctuations and sharp peaks during the later portion of the analysis, with the final measurements showing an upward trend toward the end of the time period. The similar fluctuation patterns across the three runs further demonstrate the reproducibility of the analysis. The reproducibility achieved through the automated split injection approach can improve the reliability of quantitative analysis by providing consistent detector responses for samples with the same ion concentrations across multiple analysis runs.

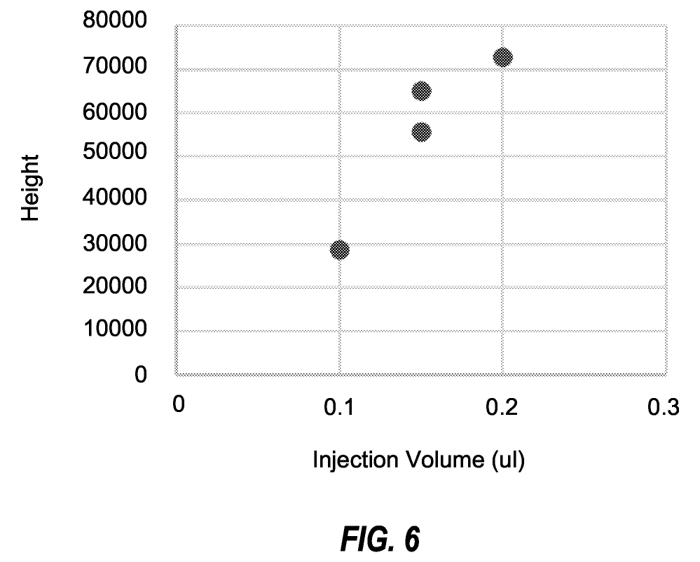

Referring to FIG. 6, a scatter plot graph is illustrated showing the relationship between injection volume and height. The horizontal axis of the scatter plot represents injection volume measured in microliters, ranging from 0 to 0.3 microliters. The vertical axis represents height, ranging from 0 to 80000. The scatter plot displays four data points that demonstrate the effect of varying injection volume on the measured peak height in the capillary electrophoresis system.

A first data point is located at approximately 0.1 microliters injection volume with a height of approximately 28000. A second data point is positioned at approximately 0.15 microliters injection volume with a height of approximately 55000. A third data point appears at approximately 0.16 microliters injection volume with a height of approximately 65000. A fourth data point is located at approximately 0.2 microliters injection volume with a height of approximately 72000.

With continued reference to FIG. 6, the data points demonstrate a positive correlation between injection volume and peak height. As the injection volume increases from 0.1 microliters to 0.2 microliters, the measured height increases from approximately 28000 to approximately 72000. The positive correlation indicates that larger volumes of sample drawn into the sampling column result in higher peak heights in the resulting electropherogram. Conversely, smaller volumes of sample drawn into the sampling column result in lower peak heights.

The variation in peak height obtained by changing the injection volume enables increased dynamic range for analysis of varying ion concentration levels. For samples with high ion concentrations, a smaller injection volume can be used to reduce the peak height and prevent detector saturation or peak overload. For samples with low ion concentrations, a larger injection volume can be used to increase the peak height and improve detection sensitivity. The ability to adjust the injection volume provides flexibility in analyzing samples with a wide range of ion concentrations using the same capillary electrophoresis system.

The injection volume can be controlled by varying the pumping time of the pump as described previously. The pump draws sample into the sampling column, and the volume of sample drawn into the sampling column is proportional to the pumping time. By adjusting the pumping time, the injection volume can be varied within the range of 0.1 to 0.2 microliters as shown in FIG. 6, or within a broader range of 0.05 to 0.3 microliters as described previously. The controlled variation of injection volume through pumping time adjustment provides a mechanism for achieving variable split ratios of sample to buffer introduced into the separation column.

The relationship between injection volume and peak height shown in FIG. 6 can be used to select an appropriate injection volume for a given sample based on the expected ion concentration. For samples with unknown ion concentrations, an initial analysis can be performed with a moderate injection volume, and the injection volume can be adjusted for subsequent analyses based on the observed peak heights. The ability to adjust the injection volume based on sample characteristics can improve the accuracy and reliability of quantitative analysis across a wide range of ion concentration levels.

The capillary electrophoresis system can be configured to analyze samples from concentrated animal feeding operations (CAFO). Concentrated animal feeding operations produce waste streams from poultry, cattle, or swine that contain multiple ionic species suitable for analysis using the capillary electrophoresis system. Poultry waste water from farms can be analyzed to determine the composition of ions including ammonium, potassium, sodium, phosphate, and other ionic species present in the waste. Cattle waste and swine waste from concentrated animal feeding operations can similarly be analyzed to characterize the ionic composition of the waste streams. The analysis of concentrated animal feeding operation waste can enable recycling of phosphates and ammonia for sustainable production of fertilizer by providing quantitative information about the ion concentrations present in the waste streams.

The capillary electrophoresis system can be configured to analyze samples from wastewater treatment plants (WWTP) for ion composition. Wastewater treatment plants process incoming waste streams that contain various ionic species, and the capillary electrophoresis system can provide analysis of the ion composition at different points in the treatment process. The system can analyze incoming feed streams to the wastewater treatment plant to characterize the initial ion composition. The system can also analyze samples taken at intermediate points in the chemical processing to monitor changes in ion composition during treatment. The analysis of wastewater treatment plant samples can support process optimization and quality control by providing information about the ionic species present in the waste streams.

The capillary electrophoresis system can provide on-line sampling capability for flow injection analysis with automated sample dilution and sensor calibration. The automated sample injection approach described previously can be extended to provide on-line sampling from process streams in concentrated animal feeding operations or wastewater treatment plants. The on-line sampling can provide composition information for incoming feed streams for membrane-based electrochemical enrichment processes and nanoparticle-based enrichment processing for phosphorus recovery. Automated sample dilution can be performed by controlling the volume of sample drawn into the sampling column relative to the buffer solution, which can adjust the effective concentration of the sample introduced into the separation column. Sensor calibration can be automated by periodically analyzing calibration standards with known ion concentrations and adjusting the calibration curves based on the measured responses.

The capillary electrophoresis system can provide close to real-time ion concentration analysis for process control studies and evaluation of beneficiated product quality. The on-line sampling of beneficiated product composition can be carried out rapidly, and the ion concentration analysis can be available in close to real-time. The close to real-time analysis provides information for process control studies by enabling monitoring of ion concentrations during processing operations. The close to real-time analysis also enables evaluation of beneficiated product quality by providing quantitative information about the ion composition of the product streams. The rapid analysis capability can support distributed modular fertilizer production systems that recycle waste streams from concentrated animal feeding operations and wastewater treatment plants.

The capillary electrophoresis system can be configured as a compact modular system with a target portable form factor approximately the size of a shoe box for field deployment. The system can utilize off-the-shelf components including pumps and valves to provide a compact configuration suitable for portable applications. The compact multi-ion analysis system can be designed to be inexpensive, sensitive, rapid, reliable, and modular for deployment at distributed locations including concentrated animal feeding operations and wastewater treatment plants. The portable form factor can enable field deployment of the capillary electrophoresis system for on-site analysis of waste streams without requiring transport of samples to a centralized laboratory. The shoe box size target form factor can provide a more portable analysis capability compared to laboratory-scale instruments such as inductively coupled plasma spectroscopy, ion chromatography, and ionization spectroscopy while maintaining the ability to analyze multiple ions at one time.

The disclosed technology can be further understood according to the following clauses:

Clause 1: A capillary electrophoresis system, comprising: a separation column configured to perform electrophoretic separation of ions; a sampling column in fluid communication with the separation column, the sampling column configured to receive a sample and a buffer solution; a pump in fluid communication with the sampling column, the pump configured to control a volume of the sample drawn into the sampling column; and a plurality of valves configured to direct fluid flow between the sampling column and the separation column, wherein actuation of the plurality of valves enables a variable split ratio of the sample volume in the sampling column relative to the buffer solution to be introduced into the separation column.

Clause 2: The capillary electrophoresis system of clause 1, further comprising a capacitively-coupled contactless conductivity detector in fluid communication with the separation column, the capacitively-coupled contactless conductivity detector configured to detect ions separated by the separation column.

Clause 3: The capillary electrophoresis system of clause 2, further comprising a data acquisition device connected to the capacitively-coupled contactless conductivity detector, the data acquisition device configured to record detection data from the capacitively-coupled contactless conductivity detector.

Clause 4: The capillary electrophoresis system of clause 1, wherein the plurality of valves comprises at least three 3-port valves configured to selectively direct fluid flow between a rinsing reservoir, a buffer reservoir, the sampling column, and the separation column.

Clause 5: The capillary electrophoresis system of clause 1, further comprising a sample reservoir in fluid communication with the sampling column through at least one of the plurality of valves.

Clause 6: The capillary electrophoresis system of clause 1, wherein the pump comprises a syringe pump configured to control a pumping time to vary the volume of the sample drawn into the sampling column.

Clause 7: The capillary electrophoresis system of clause 1, wherein the separation column has an inner diameter in a range of 75 micrometers to 150 micrometers.

Clause 8: The capillary electrophoresis system of clause 1, wherein the sampling column has an inner diameter in a range of 50 micrometers to 100 micrometers.

Clause 9: The capillary electrophoresis system of clause 1, further comprising a high voltage source configured to apply a voltage difference in a range of 5 kV to 15 kV across the separation column.

Clause 10: The capillary electrophoresis system of clause 1, wherein the volume of the sample drawn into the sampling column is in a range of 0.05 microliters to 0.3 microliters.

Clause 11: The capillary electrophoresis system of clause 1, wherein the sample comprises one or more ions selected from the group consisting of ammonium, nitrate, nitrite, phosphate, potassium, sodium, calcium, lithium, magnesium, and zinc.

Clause 12: A method for performing capillary electrophoresis, comprising: drawing a controlled volume of a sample into a sampling column using a pump, wherein the sampling column contains a buffer solution; actuating a plurality of valves to establish a fluid pathway between the sampling column and a separation column; introducing the sample from the sampling column into the separation column at a split ratio determined by the controlled volume of the sample relative to the buffer solution in the sampling column; applying a voltage across the separation column to perform electrophoretic separation of ions in the sample; and detecting the separated ions using a detector.

Clause 13: The method of clause 12, further comprising rinsing the sampling column with the buffer solution prior to drawing the controlled volume of the sample into the sampling column.

Clause 14: The method of clause 13, wherein rinsing the sampling column comprises actuating at least one of the plurality of valves to direct the buffer solution from a rinsing reservoir through the sampling column.

Clause 15: The method of clause 12, wherein the controlled volume of the sample is in a range of 0.05 microliters to 0.3 microliters.

Clause 16: The method of clause 12, further comprising adding a marker ion to the sample prior to drawing the controlled volume of the sample into the sampling column, wherein the marker ion is used to normalize elution times of other ions in the sample.

Clause 17: A capillary electrophoresis system for multi-ion analysis, comprising: a separation column having an inlet and an outlet; a sampling column connected to the inlet of the separation column, the sampling column defining a channel configured to hold a variable volume of a sample; a syringe pump configured to draw the sample into the sampling column and to control the volume of the sample in the channel; a detector positioned at the outlet of the separation column and configured to detect separated ions; and a valve arrangement configured to selectively connect the sampling column to a sample reservoir and to the separation column, wherein the valve arrangement is operable to achieve a variable split of the sample volume introduced into the separation column.

Clause 18: The capillary electrophoresis system of clause 17, wherein the detector comprises a capacitively-coupled contactless conductivity detector.

Clause 19: The capillary electrophoresis system of clause 18, further comprising a data acquisition device connected to the capacitively-coupled contactless conductivity detector, the data acquisition device configured to record detection data corresponding to the separated ions.

Clause 20: The capillary electrophoresis system of clause 17, wherein the valve arrangement comprises a plurality of electromechanical valves configured to switch between a sampling mode in which the sample is drawn into the sampling column and an analysis mode in which the sample is directed from the sampling column to the separation column.

A number of implementations have been described. Nevertheless, it will be understood that various modifications may be made without departing from the spirit and scope of the disclosure. Accordingly, other implementations are within the scope of the following claims.

What is claimed is:

1. A capillary electrophoresis system, comprising:
a separation column configured to perform electrophoretic separation of ions;
a sampling column in fluid communication with the separation column, the sampling column configured to receive a sample and a buffer solution;
a pump in fluid communication with the sampling column, the pump configured to control a volume of the sample drawn into the sampling column; and
a plurality of valves configured to direct fluid flow between the sampling column and the separation column, wherein actuation of the plurality of valves enables a variable split ratio of the sample volume in the sampling column relative to the buffer solution to be introduced into the separation column.

2. The capillary electrophoresis system of claim 1, further comprising a capacitively-coupled contactless conductivity detector in fluid communication with the separation column, the capacitively-coupled contactless conductivity detector configured to detect ions separated by the separation column.

3. The capillary electrophoresis system of claim 2, further comprising a data acquisition device connected to the capacitively-coupled contactless conductivity detector, the data acquisition device configured to record detection data from the capacitively-coupled contactless conductivity detector.

4. The capillary electrophoresis system of claim 1, wherein the plurality of valves comprises at least three 3-port valves configured to selectively direct fluid flow between a rinsing reservoir, a buffer reservoir, the sampling column, and the separation column.

5. The capillary electrophoresis system of claim 1, further comprising a sample reservoir in fluid communication with the sampling column through at least one of the plurality of valves.

6. The capillary electrophoresis system of claim 1, wherein the pump comprises a syringe pump configured to control a pumping time to vary the volume of the sample drawn into the sampling column.

7. The capillary electrophoresis system of claim 1, wherein the separation column has an inner diameter in a range of 75 micrometers to 150 micrometers.

8. The capillary electrophoresis system of claim 1, wherein the sampling column has an inner diameter in a range of 50 micrometers to 100 micrometers.

9. The capillary electrophoresis system of claim 1, further comprising a high voltage source configured to apply a voltage difference in a range of 5 kV to 15 kV across the separation column.

10. The capillary electrophoresis system of claim 1, wherein the volume of the sample drawn into the sampling column is in a range of 0.05 microliters to 0.3 microliters.

11. The capillary electrophoresis system of claim 1, wherein the sample comprises one or more ions selected from the group consisting of ammonium, nitrate, nitrite, phosphate, potassium, sodium, calcium, lithium, magnesium, and zinc.

12. A method for performing capillary electrophoresis, comprising:
drawing a controlled volume of a sample into a sampling column using a pump, wherein the sampling column contains a buffer solution;
actuating a plurality of valves to establish a fluid pathway between the sampling column and a separation column;
introducing the sample from the sampling column into the separation column at a split ratio determined by the controlled volume of the sample relative to the buffer solution in the sampling column;
applying a voltage across the separation column to perform electrophoretic separation of ions in the sample; and
detecting the separated ions using a detector.

13. The method of claim 12, further comprising rinsing the sampling column with the buffer solution prior to drawing the controlled volume of the sample into the sampling column.

14. The method of claim 13, wherein rinsing the sampling column comprises actuating at least one of the plurality of valves to direct the buffer solution from a rinsing reservoir through the sampling column.

15. The method of claim 12, wherein the controlled volume of the sample is in a range of 0.05 microliters to 0.3 microliters.

16. The method of claim 12, further comprising adding a marker ion to the sample prior to drawing the controlled volume of the sample into the sampling column, wherein the marker ion is used to normalize elution times of other ions in the sample.

17. A capillary electrophoresis system for multi-ion analysis, comprising:
a separation column having an inlet and an outlet;
a sampling column connected to the inlet of the separation column, the sampling column defining a channel configured to hold a variable volume of a sample;
a syringe pump configured to draw the sample into the sampling column and to control the volume of the sample in the channel;
a detector positioned at the outlet of the separation column and configured to detect separated ions; and
a valve arrangement configured to selectively connect the sampling column to a sample reservoir and to the separation column, wherein the valve arrangement is operable to achieve a variable split of the sample volume introduced into the separation column.

18. The capillary electrophoresis system of claim 17, wherein the detector comprises a capacitively-coupled contactless conductivity detector.

19. The capillary electrophoresis system of claim 18, further comprising a data acquisition device connected to the capacitively-coupled contactless conductivity detector, the data acquisition device configured to record detection data corresponding to the separated ions.

20. The capillary electrophoresis system of claim 17, wherein the valve arrangement comprises a plurality of electromechanical valves configured to switch between a sampling mode in which the sample is drawn into the sampling column and an analysis mode in which the sample is directed from the sampling column to the separation column.
